(19) United States
(12) Patent Application Publication
(10) Pub. No.: US 2008/0235806 A1
(43) Pub. Date: Sep. 25, 2008

(54) Methods and Apparatus for Implementing Context-Dependent File Security

(75) Inventors: David F. BANTZ, Portland, ME (US); Thomas E. Chefalas, Somers, NY (US); Steven J. Mastrianni, Unionville, CT (US); Clifford A. Pickover, Yorktown Heights, NY (US)

Correspondence Address: HARRINGTON & SMITH, PC, 4 RESEARCH DRIVE, SHELTON, CT, 06484-6212, US

(73) Assignee: International Business Machines Corporation

(21) Appl. No.: 12/131,351

(22) Filed: Jun. 2, 2008

Related U.S. Application Data
(63) Continuation of application No. 11/173,111, filed on Jul. 1, 2005.

(51) Int. Cl. H04L 9/32

(52) U.S. Cl. 726/27

(57) ABSTRACT

The present invention concerns methods and apparatus for implementing context-dependent security for files and other computer system resources. In particular, methods and apparatus of the present invention implement context-based permissions that are used in context-dependent file security. In examples of the present invention, the context-based permissions may allow access to a file only when an attempt to access the file is made at a certain time of day, or from an authorized computer system, or from a computer having a certain application program installed. In general terms, the context-based permissions may specify time, location and application information that either alone or in combination may be used to restrict access to a file.

### TECHNICAL FIELD

The present invention generally concerns computer system file security, and more particularly concerns methods and apparatus that implement file security on a contextual basis by, for example, restricting access to a file to certain computers in a networked system; or to computers having a particular application program installed; or to certain users based on a time criterion.

### BACKGROUND

Current computer file systems operating in accordance with the prior art contain relatively limited means to control how computer files are used. For example, in accordance with the prior art computer files can be marked read-only. There is currently no way to restrict the use of a computer file to a particular application, or to a particular computer, or to a particular time period.

In conventional file management systems, various restrictions respecting viewing or editing rights can be instituted in dependence either on a privilege level assigned to a user or through the user's association with a particular group. There are no restrictions, however, that define where or when a file can be used. There is no way to restrict access to files based on location or time, or to limit use of files based on the identity of a user's system.

What is needed then is a context-based file security system that contains metadata to describe who, when and where a file or certain data can be used, thereby limiting access to files or data to certain users at certain times or at certain locations.

Accordingly, those skilled in the art desire context-dependent file security systems that append novel metadata to files to control what computer systems and/or application programs can access a file; and when the file can be accessed.

In addition, those skilled in the art desire context-dependent file security systems that hide from view files not authorized to be viewed from particular computer systems, or with particular application programs. On the other hand, context-dependent file systems desired by those skilled in the art should render files visible to users who have accessed the file using an authorized computer or an authorized application program.

### SUMMARY OF THE PREFERRED EMBODIMENTS

The foregoing and other objects are overcome, and other advantages are realized, in accordance with the following embodiments of the present invention.

A first embodiment of the invention comprises a signal-bearing medium tangibly embodying a program of machine readable instructions executable by a digital processing apparatus of a computer system to perform context-based file security operations, the operations comprising: receiving a selection of at least one context-based permission to be applied to at least one file stored in a computer memory resource associated with the computer system, whereby the at least one context-based permission will be used by the computer system to control access to the at least one file; and saving the at least one context-based permission to a memory of the computer system as context-based permission information.

A second embodiment of the present invention comprises a signal-bearing medium tangibly embodying a program of machine-readable instructions executable by a digital processing apparatus of a computer system to perform context-based file security operations concerning at least one file stored in a computer memory resource associated with the computer system, the operations comprising: monitoring access requests for files stored in the computer memory resource associated with the computer system; detecting a particular access request for files stored in the computer memory resource, where the particular access request encompasses the at least one file; retrieving context-based permission information associated with the at least one file, where the context-based permission information concerns a context-based permission used to control access to the at least one file; deriving user context information from the particular access request; comparing the context-based permission saved in the context-based permission information to the user context information derived from the particular access request; and granting access to the file if the context-based permission and user context information match.

A third embodiment of the present invention comprises a signal-bearing medium tangibly embodying a program of machine-readable instructions executable by a digital processing apparatus of a computer system to perform context-based security operations, the operations comprising: receiving a selection of at least one context-based permission to be applied to at least one computer system resource associated with the computer system, whereby the at least one context-based permission will be used by the computer system to control access to the at least one computer system resource; and saving the at least one context-based permission to a memory of the computer system as context-based permission information.

A fourth embodiment of the present invention comprises a computer system for performing context-based security operations concerning at least one computer system resource, the computer system comprising: at least one memory to store at least one program of machine-readable instructions, where the at least one program performs context-based security operations concerning the at least one computer system resource when executed; at least one processor coupled to the at least one memory and computer system resource, where the at least one processor performs at least the following operations when the at least one program is executed: receiving at least one selection of a context-based permission to be applied to the at least one computer system resource, whereby the context-based permission will be used by the computer system to control access to the at least one computer system resource; and saving the at least one context-based permission to a memory of the computer system as context-based permission information.

A fifth embodiment of the present invention comprises a computer system for performing context-based security operations concerning at least one computer system resource, the computer system comprising: at least one memory to store at least one program of machine-readable instructions, where the at least one program performs context-based security operations concerning the at least one computer system resource when executed; at least one processor coupled to the at least one memory, where the at least one processor performs at least the following operations when the at least one program is executed: monitoring access to the at least one computer system resource; detecting an attempt to access the at least one computer system resource; retrieving the context-based permission information; deriving user context information from the access attempt; comparing the context-based permission saved in the context-based permission information to the user context information derived from the access attempt; and granting access to the computer system resource if the context-based permission and user context information match.

Thus it is seen that the present invention overcomes the limitations of the prior art. In particular, apparatus and methods operating in accordance with the prior art have relatively limited ability to institute context-dependent file security. For example, computer files in current electronic computer file systems can be designated as read-only, or restricted to access by certain authorized individuals or groups.

In contrast, methods and apparatus operating in accordance with the present invention establish new attributes and metadata for computer system files that describe how, when and where files can be accessed or used. These new attributes specify where physically a file can be used, or even where it is visible. The file metadata contains a certificate that must be validated by the proper application before the file can be used, edited or even viewed and made visible. Users with an authorized application, for example, can “see” files that can be operated on by the authorized application. Users without the authorized application do not “see” the files in computer systems operating in accordance with the context-dependent security system of the present invention; for users without the authorized application the files do not exist and cannot be accessed.

In addition to new metadata, new runtime software is introduced as part of the present invention to mediate file access. A policy store is introduced, to determine what actions are permissible and how to handle boundary cases, such as the case where a user has an open file and crosses the geographic boundary outside of which the file is not to be accessed while the file is still open.

In context-dependent computer file security systems operating in accordance with the present invention, users at a particular location such as a public internet site would not be able to view corporate or secure information. A context-dependent computer file security system operating in such a manner would prevent hackers from gaining access to proprietary data. Such a context-dependent computer file security system can be instituted in methods and apparatus of the present invention by appending metadata to selected computer system files that allows access to selected computer system files only from computer systems on a corporate intranet or secure network, or connected through some type of hardware or software security device. Although time specific, location-specific and application-specific metadata are given as examples, other metadata can be applied.

In computer file security systems instituting the context-dependent file security measures of the present invention, the following attributes may be used to provide security. For example, a file may only be modified under certain conditions relating to any of: vendor or package doing the modification (e.g. only an IBM software package can access a file), application (e.g., only WORD™ has permission to change a WORD™ file), location of computing resource, date of most recent change, number of times a file has been copied or printed, relevance of file to user's need, content of the entity being modified (e.g., if the system determines that the topic of a document is “encryption,” then the file may not be modified), time of day, and date.

Restricting access to a file based on file content may be particularly novel. File content or “topic” may be accessed by various known methods, such as the use of keywords, latent semantic indexing, an automatic analysis of the text, and so forth. The user may also intentionally add keywords or specify that the file is not to be modified under various conditions.

In conclusion, the foregoing summary of the embodiments of the present invention is exemplary and non-limiting. For example, one of ordinary skill in the art will understand that one or more aspects or steps from one embodiment can combined with one or more aspects or steps from another alternate embodiment to create a new embodiment within the scope of the present invention.

### BRIEF DESCRIPTION OF THE DRAWINGS

The foregoing and other aspects of these teachings are made more evident in the following Detailed Description of the Preferred Embodiments, when read in conjunction with the attached Drawing Figures, wherein:

FIG. 1 depicts a system operating in accordance with the present invention;

FIG. 2 is a flow diagram depicting a method operating in accordance with the present invention;

FIG. 3 is a flow diagram depicting a method operating in accordance with the present invention;

FIG. 4 is a flow diagram depicting a method operating in accordance with the present invention; and

FIG. 5 is a flow diagram depicting a method operating in accordance with the present invention.

### DETAILED DESCRIPTION OF THE PREFERRED EMBODIMENTS

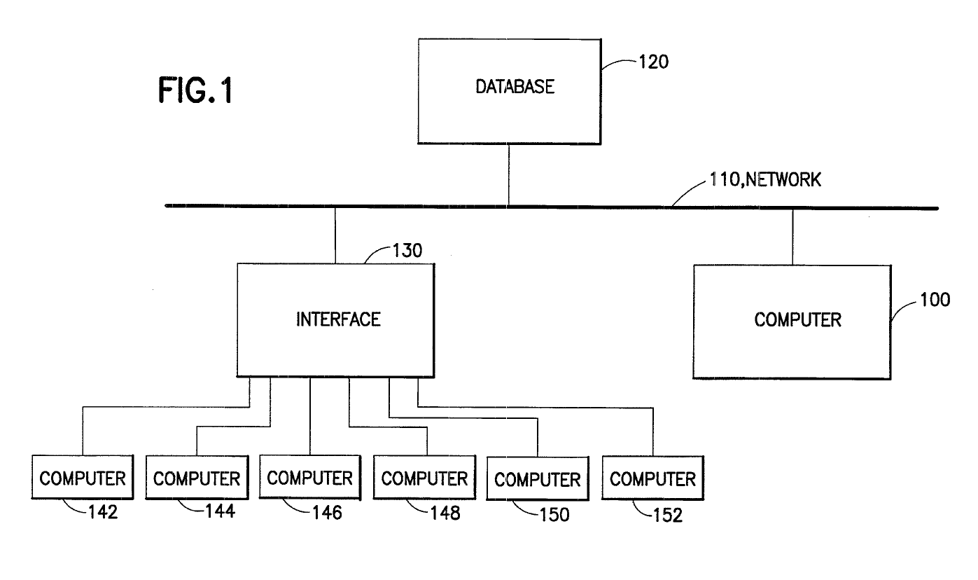

FIG. 1 depicts a system for practicing the methods of the present invention. Control computer 100 comprises a program; memory; data processor; and interactive control devices coupled to network 110. Also coupled to network 110 is a database 120 of folders and files. The network 110, in turn, is coupled to a network interface 130. Network interface 130 allows a plurality of users to access the files and folders stored in database 120. In a non-limiting example, computers seeking access to database 120 may include an on-site computer 142 in a user group; an on-site computer 144 not associated with the user group; an off-site computer 146 possessed by a third party; an off-site computer 148 possessed by a member of the user group; a computer 150 having a particular application program installed; and another computer 152 not having a particular application program installed.

In operation, users operating through computers 142, 144, 146, 148, 150 and 152 seek access to computer system resources (such as, for example, files, folders, application programs, network resources, etc.) stored on database 120, or elsewhere accessible through network 110. In the particular example described with respect to FIG. 1, it will be assumed that the computer system resource is a file. Each of the files stored on database 120 have various context-based security permissions associated with them. For example, a first file may be accessed only by computers associated with a user group. In such a situation, users having access to computers 142 and 146 would be permitted access to the file, while other users attempting access from other computers would not. In another example; a second file stored in database 120 may only be accessed from computers having a particular application program installed. Assuming computer 150 is the only computer having the particular application program installed; only a user accessing the second file through the agency of the application program resident on computer 150 would be granted access to the second file.

Other context-based permissions operating in accordance with the present invention may allow users to access a third file from any of the computers under certain circumstances. For example, a context-based permission concerning the time of day a third file may be accessed would permit access to the third file from any of the computers as long as the time criterion was satisfied. Other context-based permissions concerning the number of times a file can be accessed or printed similarly would permit access from any of the computers as long as the permission criterion was satisfied.

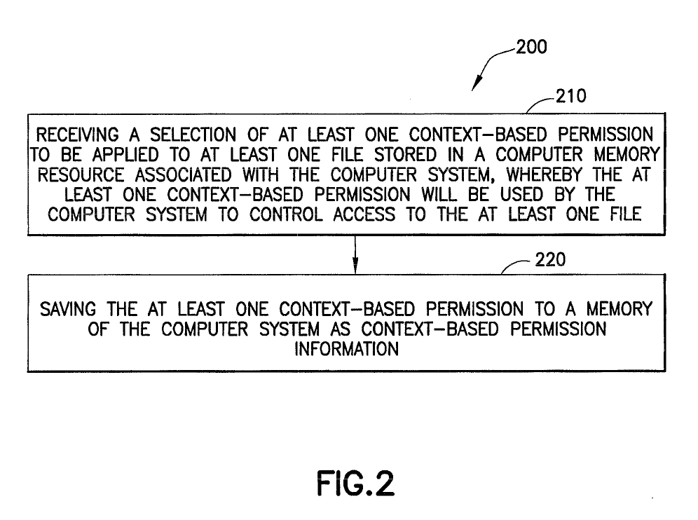

A method 200 operating in accordance with the present invention is depicted in FIG. 2. Generally, a user or automated process accesses a software instrumentality associated with an application program, operating system, or file system of a computer system to establish a context-based permission. These user-performed steps are not within the scope of the method depicted in FIG. 2, but they are nonetheless an aspect of this invention. The steps depicted in FIG. 2 are performed by a software program associated with the computer system. In addition, the method depicted in FIG. 2, and other methods described herein, can be tangibly embodied in a signal-bearing medium comprised of machine-readable instructions which carry out the methods of the present invention when executed. These tangible embodiments—such as, for example, on a hard drive, floppy disk, CD- or DVD-ROM, flash storage device, or in RAM memory associated with a computer system—are all within the scope of the present invention.

At step 210, the computer system receives a selection of at least one context-based permission to be applied to at least one file stored in a computer memory resource associated with the computer system, whereby the at least one context-based permission will be used by the computer system to control access to the at least one file. Then at step 220, the computer system executes a step of the method which saves the context-based permission to a memory of the computer system as context-based permission information.

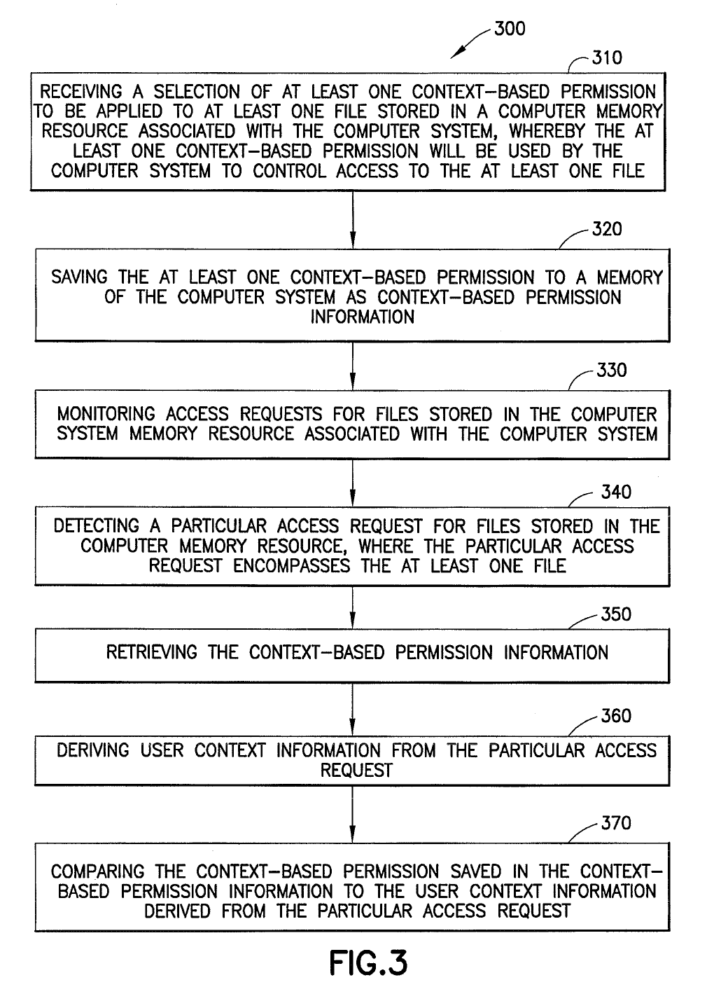

The steps of the method depicted in FIG. 2 are generally concerned with the institution of a context-based permission to control access to a file stored in a computer memory resource of a computer system. Another aspect of the present invention concerns application of the context-based permissions when an attempt to access the file is made. Both steps of a method 300 for instituting a context-based permission and for applying the context-based permission to control access to a file are depicted in FIG. 3. Again, as in the case of the method depicted in FIG. 2, the steps depicted in FIG. 3 are not performed by a user, but instead by a software instrumentality associated with a computer system. Nonetheless, again as in the case of the method depicted in FIG. 2, the initial steps where a user or automated process accesses a software instrumentality to select the context-based permission is also an aspect of the present invention.

At step 310 of the method 300, the computer system receives a selection of at least one context-based permission to be applied to at least one file stored in a computer memory resource associated with the computer system, whereby the at least one context-based permission will be used by the computer system to control access to the at least one file. Then, at step 320, the computer system saves the at least one context-based permission to a memory of the computer system as context-based permission information. Next, at step 330, the computer system monitors access requests for files stored in the computer system memory resource associated with the computer system. Then, at step 340, the computer system detects a particular access request for files stored in the computer memory resource, where the particular access request encompasses the at least one file. Next, at step 350, the computer system retrieves the context-based permission information. Then, at step 360, the computer system derives user context information from the particular access request. Next, at step 370, the computer system compares the context-based permission information to the user context information derived from the particular access request.

In variants of the method depicted in FIG. 3, the context-based permission may concern an authorized use context. In these variants, if the comparison made at step 370 determines that the user context information does not match the authorized use context reflected in the context-based permission, the computer system masks the at least one file from the entity that issued the particular access request. Accordingly, in this variant, the entity will not learn of the existence of the file. In another variant of the method depicted in FIG. 3, if the user context information does match the authorized use context, the existence of the at least one file will be revealed to the entity that issued the particular access request. In yet another variant of the method depicted in FIG. 3, if the user context information does match the authorized use context, the entity that issued the particular access request will also be granted access to the at least one file.

One of ordinary skill in the art will understand that an access request within the context of the present invention can take many forms. For example, “an access request” may occur when a user issues a search request through a browser, search engine or a file search feature of a file system. If the entity issuing the search request, which is treated as “an access request” within the context of the present invention, does not satisfy the context-based permission, then the existence of a file which otherwise satisfies the search request of the entity will not be revealed to the entity. Another example of an “access request” within the context of the present invention occurs when a user accesses a file tree composed of files and folders. Prior to the entity being allowed to peruse the contents of the file tree structure, the computer system will compare the context-based permissions for all of the contents of the file tree against the user context information evident from the access attempt of the entity. Only those elements of the file tree for which the context-based permissions are satisfied by the entity will be visible to the entity. One skilled in the art will understand that other access requests are possible within the context of the present invention.

The methods depicted in FIGS. 2 and 3 can be carried out by a software instrumentality associated with an application program; an operating system; or a file system.

In another variant of the method depicted in FIG. 3, the computer system continues to monitor the entity that issued the particular access request in order to determine if the entity's use of the file continues to comply with the authorized use context. In this variant, the computer system periodically updates the user context information associated with the entity based on the monitoring activities to create updated user context information. Then, the computer system periodically compares the updated user context information with the authorized use context contained in the context-based permission. As soon as it is determined that the user context information no longer satisfies the authorized use context, access to the at least one file is terminated.

In various embodiments of the present invention, different context-based permissions may be implemented to control access to a file. For example, in one embodiment the context-based permission restricts access to the at least one file to a particular time period such as, for example, certain hours during the day; or certain days of the week; or certain months of the year, etc. In another embodiment, the context-based permission restricts access to the at least one file to access through a particular authorized application program or programs. If an access attempt is made through another application program, and not the authorized program or programs, access will be denied.

In still further embodiments, the context-based permission restricts access to a file based on an aspect of identity relevant to computer systems. For example, the context-based permission can restrict access to a file to a particular computer or groups of computers. In another example, the context-based permission can restrict access to a file to computers resident in certain domains. In a further example, the context-based permission can restrict access based on geographic location. If it is determined that an access request is made from a region of the world notorious for on-line scams, then access will be denied. In yet another example of identity, the context-based permission can restrict access to a file based on application program vendor identity. This would allow a user to prevent entities from using a file with application programs not marketed by, for example, IBM.

In other embodiments, the context-based permission restricts access to a file based on whether the access attempt is made through an authorized security instrumentality. In one example, the context-based permission can restrict access to a file to access made through an authorized hardware security device. In another example, the context-based permission can restrict access to a file to access using an authorized security application.

In further embodiments, the context-based permission can restrict the number of times that a file operation may be performed on a file to a predetermined number. In such an embodiment, this context-based permission could be used to restrict the number of times a file is accessed; or the number of times a file is copied; or the number of times a file is printed; or the number of times a file is modified; or the number of times a file is downloaded.

In variants of the methods depicted in FIGS. 2 and 3, multiple-state context-based permissions can be instituted to govern access to files. Further, the multiple-state context-based permissions may be hierarchical in nature. For example, several entities may be granted access to files, but certain entities may have broader access to files then other entities.

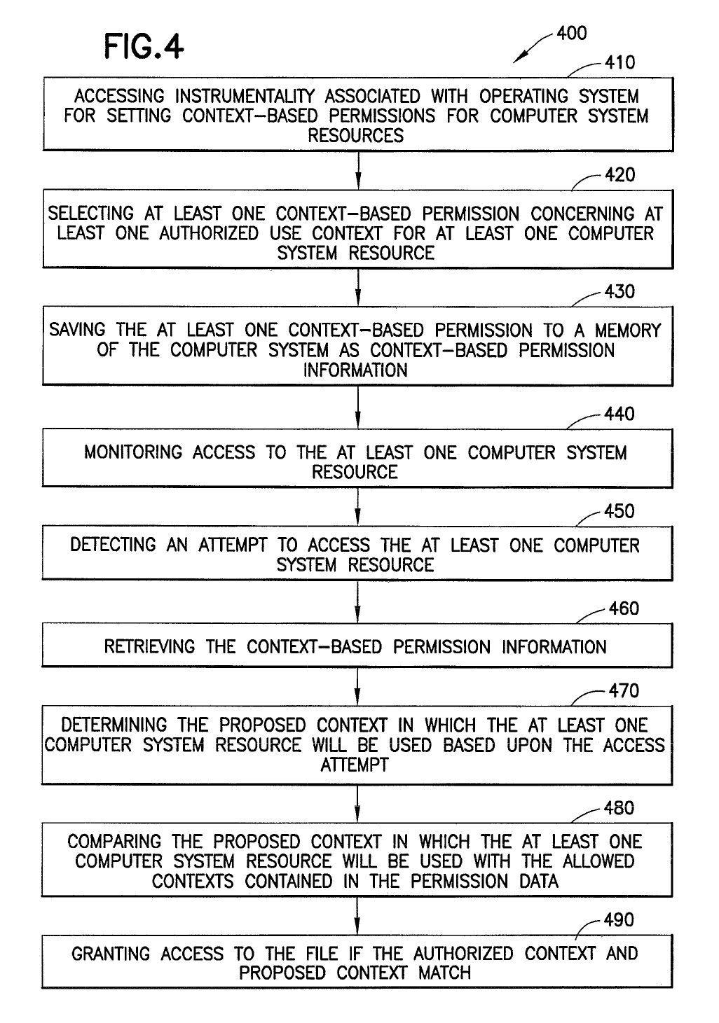

In addition to files, as indicated previously, the methods and apparatus of the present invention can be applied to a broader set of resources including, but not limited to, folders, databases, hardware resources, networks, network interfaces, etc. These resources are generally referred to in this application as “computer system resources.” Computer system resources further encompass any computer-related asset for which it is useful to govern access. FIG. 4 depicts method 400 which applies the teachings of the present invention to restrict access to computer system resources based on context-based permissions. In the method 400 depicted in FIG. 4, an instrumentality for instituting context-based permissions is associated with an operating system. At step 410, the instrumentality associated with the operating system is accessed to set context-based permissions for computer system resources. Then, at step 420, at least one context-based permission is selected concerning at least one authorized use context for at least one computer system resource. Next, at step 430, the at least one context-based permission is saved to a memory of the computer system as context-based permission information. Then, at step 440 access to the at least one computer system resource is monitored. At step 450, the method detects an attempt to access the at least one computer system resource. Next, at step 460, the method retrieves the context-based permission information. Then, at step 470, the method determines the proposed context in which the at least one computer system resource will be used based upon the access attempt. Next, at step 480, the method compares the proposed context in which the at least one computer system resource will be used with the allowed contexts contained in the permission data. Then, at step 490, access to the file is granted if the authorized context and proposed context match.

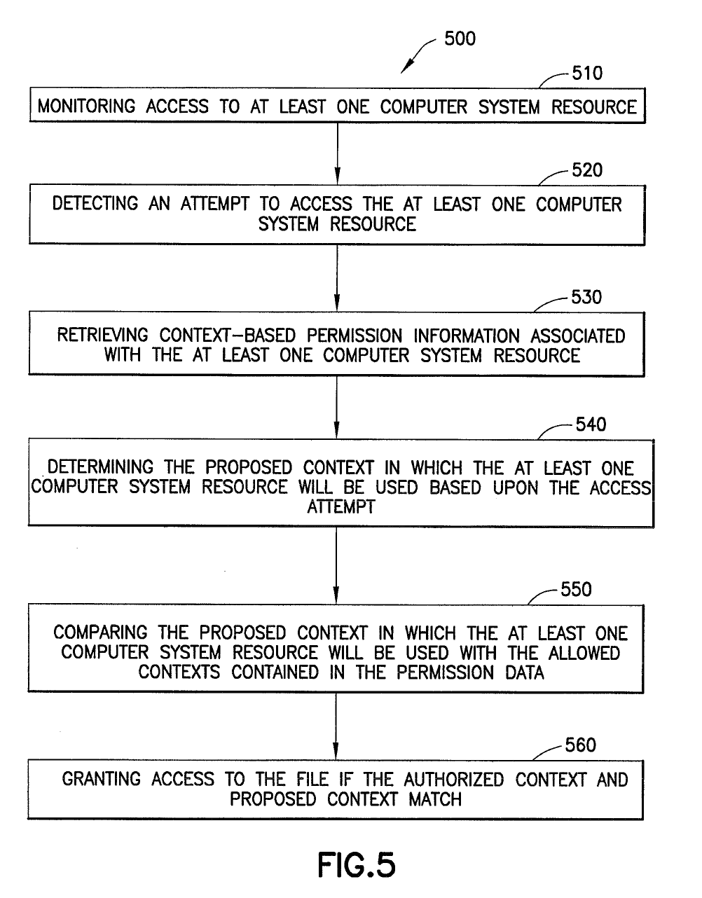

In addition to the methods depicted in FIGS. 2-4 which generally concern at least the institution of context-based permissions possibly combined with the application of the context-based permissions to control access to files and other computer system resources, the methods of the present invention also concern just the application of context-based permissions assuming context-based permissions have already been established. Such a method 500 is depicted in FIG. 5. At step 510, the method monitors access to at least one computer system resource. Then, at step 520, the computer system detects an attempt to access the at least one computer system resource. Next, at step 530, the computer system retrieves context-based permission information associated with the at least one computer system resource. Then, at step 540, the computer system determines a proposed context in which the at least one computer system resource will be used based upon the access attempt. Next, at step 550, the computer system compare the proposed context in which the at least one computer system resource will be used with the allowed contexts contained in the permission data. Then, at step 560, the method grants access to the file if the authorized context and the proposed context match.

In embodiments of the present invention, the context-based permissions can be instituted in various ways. For example, a file can be encrypted by a context-specific key that is generated based on the context permissions. The key is then saved in a key store. When the file is accessed, a key is generated for the current context, and that key is compared with the key in the key store to see if it is a match or within a specified range. If so, file access is permitted. If not, file access is denied.

In other embodiments, the methods and apparatus of the invention establish a secure hidden database of file metadata which is accessed by the file system for displaying or accessing files or configuration information on storage 120. Files and data may contain digital certificates to validate that the program that is attempting access to the file or data does not indeed have the right or privilege to view or edit the data. The metadata can optionally be deployed as part of a policy by IT administrators, and later attached to a particular file or files so as to limit access to those files.

The present invention can be implemented as an extension to an existing file system provided by the operating system, or by the middleware that mediates access to files. In either case, actions to access files are mediated and approved or denied according to the file metadata or to local policies expressed as file metadata to determine how the file can be used.

Thus it is seen that the foregoing description has provided by way of exemplary and non-limiting examples a full and informative description of the best method and apparatus presently contemplated by the inventors for implementing context-dependent file security. One skilled in the art will appreciate that the various embodiments described herein can be practiced individually; in combination with one or more other embodiments described herein; or in combination with context-dependent file security systems differing from those described herein. Further, one skilled in the art will appreciate that the present invention can be practiced by other than the described embodiments; that these described embodiments are presented for the purposes of illustration and not of limitation; and that the present invention is therefore limited only by the claims which follow.

We claim:

1. A signal-bearing medium tangibly embodying a program of machine readable instructions executable by a digital processing apparatus of a computer system to perform context-based file security operations, the operations comprising:
receiving a selection of at least one context-based permission to be applied to at least one file stored in a computer memory resource associated with the computer system, whereby the at least one context-based permission will be used by the computer system to control access to the at least one file; and
saving the at least one context-based permission to a memory of the computer system as context-based permission information.

2. The signal-bearing medium of claim 1 where the operations further comprise:
monitoring access requests for files stored in the computer memory resource associated with the computer system;
detecting a particular access request for files stored in the computer memory resource, where the particular access request encompasses the at least one file;
retrieving the context-based permission information;
deriving user context information from the particular access request; and
comparing the context-based permission saved in the context-based permission information to the user context information derived from the particular access request.

3. The signal-bearing medium of claim 2 whereby the context-based permission concerns an authorized use context and where the operations further comprise:
masking the existence of the at least one file from an entity that issued the particular access request when the user context information does not match the authorized use context.

4. The signal-bearing medium of claim 2 whereby the context-based permission concerns an authorized use context and where the operations further comprise:
revealing the existence of the at least one file to an entity that issued the particular access request when the user context information matches the authorized use context.

5. The signal-bearing medium of claim 2 whereby the context-based permission concerns an authorized use context and where the operations further comprise:
granting access to the at least one file to an entity that issued the particular access request when the user context information matches the authorized use context.

6. The signal-bearing medium of claims 5 where the operations further comprise:
monitoring the entity that issued the particular access request;
periodically updating the user context information associated with the entity based on the monitoring activities to create updated user context information;
periodically comparing the updated user context information with the authorized use context contained in the context-based permission; and
terminating access to the at least one file when the updated user context information no longer complies with the authorized use context.

7. The signal-bearing medium of claim 1 where the context-based permission is instituted through an instrumentality of an application program.

8. The signal-bearing medium of claim 1 where the context-based permission is instituted through an instrumentality of an operating system.

9. The signal-bearing medium of claim 1 where the context-based permission is instituted through an instrumentality of a file system.

10. The signal-bearing medium of claim 1 where the context-based permission restricts access to the at least one file to a particular time period.

11. The signal-bearing medium of claim 1 where the context-based permission restricts access to the at least one file to a particular application program.

12. The signal-bearing medium of claim 1 where the context-based permission restricts access to the at least one file based on at least one item selected from the group of: computer identity; domain identity; geographic identity.

13. The signal-bearing medium of claim 1 where the context-based permission restricts access to the at least one file based on vendor identity, where vendor identity concerns the identity of a vendor that originated an application program seeking access to the at least one file.

14. The signal-bearing medium of claim 1 where the context-based permission restricts access to the at least one file based on content of the at least one file.

15. The signal-bearing medium of claim 1 where the context-based permission restricts access to the at least one file based on a topic of the at least one file.

16. The signal-bearing medium of claim 1 where the context-based permission restricts access to the at least one file based on keywords contained in the at least one file.

17. The signal-bearing medium of claim 1 where the context-based permission restricts access to the at least one file to access through a particular hardware security device.

18. The signal-bearing medium of claim 1 where the context-based permission restricts access to the at least one file to access through a particular security application.

19. The signal-bearing medium of claim 1 where the context-based permission restricts a number of times that a file operation may be performed on the at least one file to a predetermined number, where the file operation comprises at least one task selected from the group of: accessing the at least one file; copying the at least one file; modifying the at least one file; downloading the at least one file; printing the at least one file.

20. The signal-bearing medium of claim 1 where the context-based permission information is saved to metadata associated with the at least one file.

21. The signal-bearing medium of claim 1 where the context-based permission concerns multiple contexts where access to the at least one file will be controlled.

22. The signal-bearing medium of claim 21 where the multiple contexts institute a hierarchical context-based permission system.

23. The signal-bearing medium of claim 22 where different context-based permissions are granted to different entities.

24. A signal-bearing medium tangibly embodying a program of machine-readable instructions executable by a digital processing apparatus of a computer system to perform context-based file security operations concerning at least one file stored in a computer memory resource associated with the computer system, the operations comprising:
monitoring access requests for files stored in the computer memory resource associated with the computer system;
detecting a particular access request for files stored in the computer memory resource, where the particular access request encompasses the at least one file;
retrieving context-based permission information associated with the at least one file, where the context-based permission information concerns a context-based permission used to control access to the at least one file;
deriving user context information from the particular access request;
comparing the context-based permission saved in the context-based permission information to the user context information derived from the particular access request; and
granting access to the file if the context-based permission and user context information match.

25. A signal-bearing medium tangibly embodying a program of machine-readable instructions executable by a digital processing apparatus of a computer system to perform context-based security operations, the operations comprising:
receiving a selection of at least one context-based permission to be applied to at least one computer system resource associated with the computer system, whereby the at least one context-based permission will be used by the computer system to control access to the at least one computer system resource; and
saving the at least one context-based permission to a memory of the computer system as context-based permission information.

26. The signal-bearing medium of claim 25 where the operations further comprise:
detecting an access request for the computer system resource;
retrieving the context-based permission information;
deriving user context information from the access request;
comparing the context-based permission saved in the context-based permission information to the user context information derived from the particular access request; and
granting access to the computer system resource if the context-based permission and user context information match.

27. The signal-bearing medium of claim 25 where the at least one computer system resource comprises at least one item selected from the group of: file, folder, application program, network, network interface, database.

28. A computer system for performing context-based security operations concerning at least one computer system resource, the computer system comprising:
at least one memory to store at least one program of machine-readable instructions, where the at least one program performs context-based security operations concerning the at least one computer system resource when executed;
at least one processor coupled to the at least one memory and computer system resource, where the at least one processor performs at least the following operations when the at least one program is executed:
receiving at least one selection of a context-based permission to be applied to the at least one computer system resource, whereby the context-based permission will be used by the computer system to control access to the at least one computer system resource; and
saving the at least one context-based permission to a memory of the computer system as context-based permission information.

29. The computer system of claim 28 where the operations further comprise:
detecting an access request for the computer system resource;
retrieving the context-based permission information;
deriving user context information from the access request;
comparing the context-based permission saved in the context-based permission information to the user context information derived from the access request; and
granting access to the computer system resource if the context-based permission and user context information match.

30. The computer system of claim 28 where the at least one computer system resource comprises at least one item selected from the group of: file, folder, application program, network, network interface, database.

31. A computer system for performing context-based security operations concerning at least one computer system resource, the computer system comprising:
at least one memory to store at least one program of machine-readable instructions, where the at least one program performs context-based security operations concerning the at least one computer system resource when executed;
at least one processor coupled to the at least one memory, where the at least one processor performs at least the following operations when the at least one program is executed:
monitoring access to the at least one computer system resource;
detecting an attempt to access the at least one computer system resource;
retrieving the context-based permission information;
deriving user context information from the access attempt;
comparing the context-based permission saved in the context-based permission information to the user context information derived from the access attempt; and
granting access to the computer system resource if the context-based permission and user context information match.

32. The computer system of claim 31 where the at least one computer system resource comprises at least one item selected from the group of: file, folder, application program, network, network interface, database.
